(19) United States
(12) Patent Application Publication
(10) Pub. No.: US 2019/0303821 A1
(43) Pub. Date: Oct. 3, 2019

(54) SUPPLY CHAIN RISK MANAGEMENT SYSTEM AND METHOD

(71) Applicant: International Business Machines Corporation, Armonk, NY (US)

(72) Inventor: Aleh Khomich, Kaufering (DE)

(21) Appl. No.: 15/938,222

(22) Filed: Mar. 28, 2018

(51) Int. Cl. G06Q 10/06; G06Q 10/08

(52) U.S. Cl. CPC G06Q 10/0635; G06F 3/04883; G06Q 10/08; G06Q 10/0639

(57) ABSTRACT

Disclosed embodiments provide techniques for supply chain risk management that include user input quality as a factor in risk computation. User input errors can be a factor in supply chain risk management. Account numbers, part numbers, and quantities, if entered erroneously, can give a false picture of the state of the supply chain. A user input quality score is computed based on a deviation between a training set of user input data and a measured set of user input data. The deviation between the training set and the measured set can be associated with risk of user input error. A larger deviation can be indicative of a higher probability of an input error. The user input can include keyboard input, mouse input, touchscreen input, or other suitable input methods. In this way, a more complete assessment of supply chain risk can be computed and presented to product stakeholders.

### FIELD OF THE INVENTION

Embodiments of the present invention relate to supply chain risk management and, more particularly, to methods, devices, and computer program products that provide techniques for supply chain risk management that include user input quality as a factor in risk computation.

### BACKGROUND

Risk management is the identification, evaluation, and prioritization of risks with appropriation and application of resources to monitor, control, and mitigate the likelihood or effect of events which would produce a negative impact, or to maximize the realization of opportunities. The objective is to keep uncertainty from deflecting the business goals. Non-limiting examples of risk types include demand risks, supply risks, environmental risks, business risks, physical plant risks, and mitigation and contingency risks. There exists a need for improvements in automated risk management.

### SUMMARY

In one embodiment, there is provided a computer-implemented method for assessing supply chain risk, comprising: obtaining a plurality of supply chain risk factors for a supply chain; obtaining a user input quality risk factor; computing a risk score for a supply chain based on the obtained supply chain risk factors and the user input quality risk factor; and presenting a risk warning on an electronic display, wherein the risk warning is based on the risk score.

In another embodiment, there is provided an electronic computation device comprising: a processor; a memory coupled to the processor, the memory containing instructions, that when executed by the processor, perform the steps of: obtaining a plurality of supply chain risk factors for a supply chain; obtaining a user input quality risk factor; computing a risk score for a supply chain based on the obtained supply chain risk factors and the user input quality risk factor; and presenting a risk warning on an electronic display, wherein the risk warning is based on the risk score.

In yet another embodiment, there is provided a computer program product for an electronic computation device comprising a computer readable storage medium having program instructions embodied therewith, the program instructions executable by a processor to cause the electronic computation device to: obtain a plurality of supply chain risk factors for a supply chain; obtain a user input quality risk factor; compute a risk score for a supply chain based on the obtained supply chain risk factors and the user input quality risk factor; and present a risk warning on an electronic display, wherein the risk warning is based on the risk score.

### BRIEF DESCRIPTION OF THE DRAWINGS

Features of the disclosed embodiments will be more readily understood from the following detailed description of the various aspects of the invention taken in conjunction with the accompanying drawings.

FIG. 1 is a diagram for an environment of embodiments of the present invention.

FIG. 2 is a device in accordance with embodiments of the present invention.

FIG. 3A is a diagram illustrating a release-press interval.

FIG. 3B is a diagram illustrating a release-release interval.

FIG. 3C is a diagram illustrating a dwell interval.

FIG. 3D is a diagram illustrating a flight time interval.

FIG. 3E is a diagram illustrating a digraph interval.

FIG. 3F is a diagram illustrating a trigraph interval.

FIG. 4 is a sequence diagram illustrating an initial training process in accordance with embodiments of the present invention.

FIG. 5 is a sequence diagram illustrating a login process in accordance with embodiments of the present invention.

FIG. 6 is a sequence diagram illustrating supply chain risk model adjustment based on keystroke evaluation in accordance with embodiments of the present invention.

FIG. 7 is a flowchart indicating process steps for embodiments of the present invention.

FIG. 8 is a flowchart indicating process steps for additional embodiments of the present invention.

FIG. 9 is a flowchart indicating process steps for additional embodiments of the present invention.

FIG. 10A and FIG. 10B show examples of performing a mouse usage analysis of a user.

FIG. 11 shows a timing table for a mouse usage analysis.

FIG. 12A-12C show examples of performing a touchscreen usage analysis of a user.

FIG. 13 shows a timing table for a touchscreen usage analysis.

FIG. 14 shows an exemplary risk warning in accordance with embodiments of the present invention.

FIG. 15 shows an exemplary retraining prompt user interface in accordance with embodiments of the present invention.

The drawings are not necessarily to scale. The drawings are merely representations, not necessarily intended to portray specific parameters of the invention. The drawings are intended to depict only example embodiments of the invention, and therefore should not be considered as limiting in scope. In the drawings, like numbering may represent like elements. Furthermore, certain elements in some of the figures may be omitted, or illustrated not-to-scale, for illustrative clarity.

### DETAILED DESCRIPTION

Disclosed embodiments provide techniques for supply chain risk management that include user input quality as a factor in risk computation. User input errors can be a factor in supply chain risk management. Account numbers, part numbers, and quantities, if entered erroneously, can give a false picture of the state of the supply chain. A user input quality score is computed based on a deviation between a training set of user input data and a measured set of user input data. The deviation between the training set and the measured set can be associated with risk of user input error. A larger deviation can be indicative of a higher probability of an input error. The user input can include keyboard input, mouse input, touchscreen input, or other suitable input methods. In this way, a more complete assessment of supply chain risk can be computed and presented to stakeholders such as product managers, operations management, logistics managers, sales managers, and market forecasters.

Reference throughout this specification to “one embodiment,” “an embodiment,” “some embodiments”, or similar language means that a particular feature, structure, or characteristic described in connection with the embodiment is included in at least one embodiment of the present invention. Thus, appearances of the phrases “in one embodiment,” “in an embodiment,” “in some embodiments”, and similar language throughout this specification may, but do not necessarily, all refer to the same embodiment.

Moreover, the described features, structures, or characteristics of the invention may be combined in any suitable manner in one or more embodiments. It will be apparent to those skilled in the art that various modifications and variations can be made to the present invention without departing from the spirit and scope and purpose of the invention. Thus, it is intended that the present invention cover the modifications and variations of this invention provided they come within the scope of the appended claims and their equivalents. Reference will now be made in detail to the preferred embodiments of the invention.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, or “has” and/or “having”, when used in this specification, specify the presence of stated features, regions, integers, steps, operations, elements, and/or components, but do not preclude the presence or addition of one or more other features, regions, or elements.

Risk management is the identification, evaluation, and prioritization of risks in order to monitor, control, and mitigate the likelihood or effect of events which would produce a negative impact, or to maximize the realization of opportunities. The objective is to keep uncertainty from deflecting the business goals. Non-limiting examples of risk types include:
Demand risks—Caused by unpredictable end-customer demand or misunderstood customer base
Supply risks—Caused by any disruptions to the flow of product, whether raw material or fabricated pieces, within a supply chain
Environmental risks—Caused by factors external to the supply chain; which may be related to economic, social, governmental, terrorism, or climate issues
Business risks—Caused by factors such as a supplier's financial status or management capabilities, or purchase and sale of companies, which are suppliers
Physical plant risks—Caused by the state of a supplier's physical facility and regulatory compliance
Mitigation and contingency risks—Caused by failure to provide contingencies in case an issue arises

Human factors play an important role in the risk management process and are taken into account by embodiments of the present invention. Quality and authenticity of input data for risk assessment in integrated supply chain are key factors for providing effective risk analysis. The problem addressed by disclosed embodiments is that of providing effective ways to identify human factor influence on data input phase of risk assessment process.

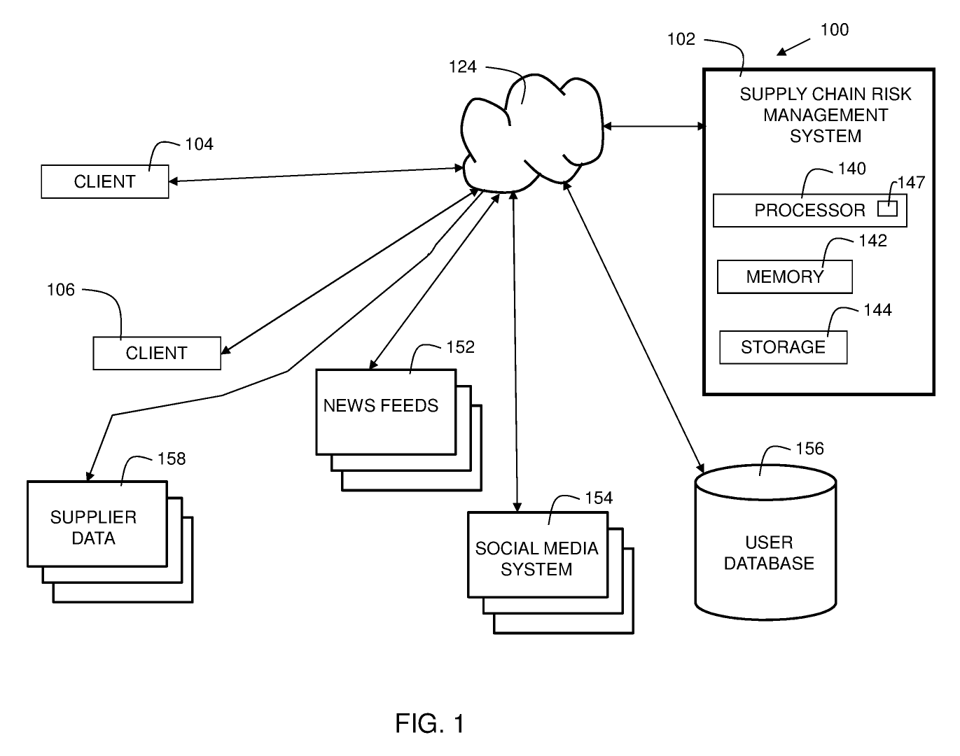

FIG. 1 is a diagram 100 for an environment of embodiments of the present invention. Supply chain risk management system may execute the elements of embodiments of the present invention. System 102 may include a processor 140, memory 142, and storage 144. System 102 may calculate risk based on a training user input sequence and a monitored user input sequence. The memory 142 contains instructions 147, that when executed by processor 140, perform steps in accordance with embodiments of the present invention.

Client 104 and client 106 are in communication with system 102 via a network 124. Network 124 may be the Internet, or a wide area network, a local area network, a cloud network, or other suitable network. A user may enter input to a client using a keyboard, mouse, touchscreen, or other suitable input methods. In the example, only two clients are shown. In implementations, more or fewer than two clients may be in communication with system 102.

Also in communication through the network are supplier data 158, news feeds 152, social media system 154, and user database 156. Supplier data 158 may come from various vendors, including, but not limited to, manufacturers, wholesale distributors, and/or retailers. News feeds 152 may be websites such as from news outlets, for example, ABC®, NBC®, CBS®, CNN®, and/or Fox®. Social media system 154 may be a social media platform, such as Facebook®, Linkedln®, Twitter®, or other suitable social media system now known or hereafter developed. Natural language processing (NLP) may be used to scrape information from news feeds 152 and/or social media system 154 to detect potential risks. For example, a news article from a news source 152 may be scraped to locate information about political turmoil or a natural disaster in a country where a supplier is located. This information can be used to detect and assess risk. In another example, a trend detected from social media system 154 can be indicative of an upcoming change in demand for a product or material.

User database 156 stores user data. The user data may be saved into profiles such that each user's data is associated with the particular user. This may be in the form of databases, or other suitable data structures. User database 156 holds the training user input sequence data for users. The training data is their typical user entry pattern. The training user input sequence data can be generic (e.g., type a sentence or two), or specific, user interaction with the actual program they are using (e.g., the inventory management system).

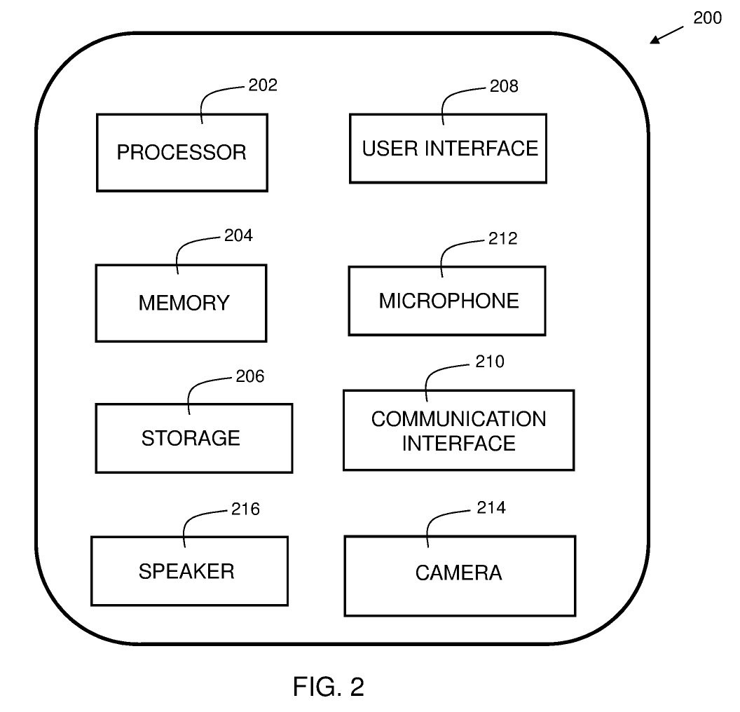

FIG. 2 is a device in accordance with embodiments of the present invention. Device 200 is an electronic computing device. Device 200 includes a processor 202, which is coupled to a memory 204. Memory 204 may include dynamic random access memory (DRAM), static random access memory (SRAM), magnetic storage, and/or a read only memory such as flash, EEPROM, optical storage, or other suitable memory. In some embodiments, the memory 204 may not be a transitory signal per se. Memory 204 stores instructions, which when executed by the processor, implement the steps of the present invention.

Device 200 may further include storage 206. In embodiments, storage 206 may include one or more magnetic storage devices such as hard disk drives (HDDs). Storage 206 may additionally include one or more solid state drives (SSDs).

Device 200 further includes a user interface 208, examples of which include a liquid crystal display (LCD), a plasma display, a cathode ray tube (CRT) display, a light emitting diode (LED) display, an organic LED (OLED) display, or other suitable display technology. The user interface 208 may further include a keyboard, mouse, or other suitable human interface device. In some embodiments, user interface 208 may be a touch screen, incorporating a capacitive or resistive touch screen in some embodiments.

The device 200 further includes a communication interface 210. The communication interface 210 may be a wired communication interface that includes Ethernet, Gigabit Ethernet, or the like. In embodiments, the communication interface 210 may include a wireless communication interface that includes modulators, demodulators, and antennas for a variety of wireless protocols including, but not limited to, Bluetooth™, Wi-Fi, and/or cellular communication protocols for communication over a computer network.

Device 200 may further include camera 214. The camera may be integral with the device as shown or connected thereto via a wired or wireless connection. The device 200 may further include a microphone 212 used for making recordings, phone calls, or other sound recordings. The device 200 may further include speaker 216, which can be used for presenting audio to the user. The audio can include music or other audio-only media, and/or audio soundtracks from video media.

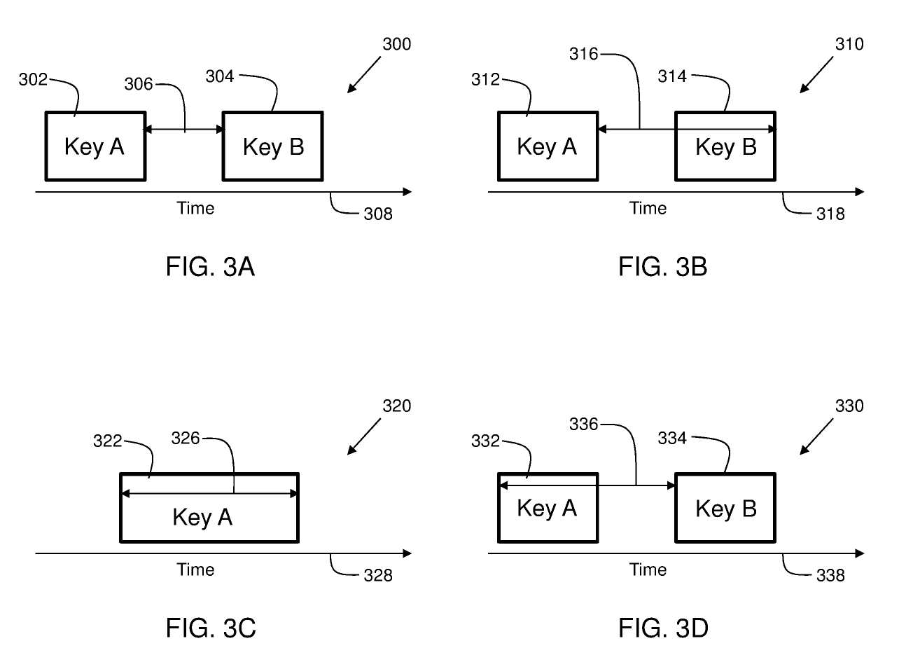

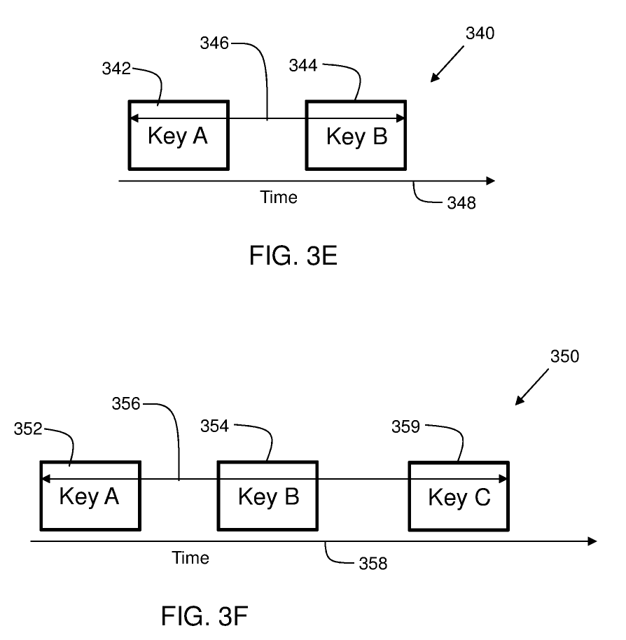

FIGS. 3A-3F shows examples of keystroke intervals. In embodiments, the monitored user input sequence comprises a keystroke sequence (of intervals). The sequence may analyze mean typing rate, inter-interval comparison, digraph, and/or trigraph keystroke sequences. Keystroke dynamic metrics include the detailed timing information which describes when each key was pressed and when it was released when a person is typing on a computer keyboard. Keystroke dynamic metrics for one user will vary in different conditions. The amount of deviation between a training user input sequence and a monitored user input sequence calculated at runtime can be used as an indication of a sub-optimal user condition. Thus, disclosed embodiments can monitor suboptimal user conditions and use this information as part of an evaluation risk assessment by adding general risk indicators to the risk model.

FIG. 3A is a diagram 300 illustrating a release-press interval. In embodiments, the keystroke sequence includes the release-press interval. This is the duration 306, on a time axis 308, between releasing Key A 302 and pressing Key B 304.

FIG. 3B is a diagram 310 illustrating a release-release interval. In embodiments, the keystroke sequence includes the release-release interval. This is the duration 316, on a time axis 318, between releasing Key A 312 and releasing Key B 314.

FIG. 3C is a diagram 320 illustrating a dwell interval. In embodiments, the keystroke sequence includes the dwell interval. This is the duration 326, on a time axis 328, while Key A 322 is pressed. Accordingly, this is the duration between the pressing and releasing of Key A 322.

FIG. 3D is a diagram 330 illustrating a flight time interval. In embodiments, the keystroke sequence includes the flight time interval. This is the duration 336, on a time axis 338, between pressing Key A 332 and pressing Key B 334 (press-press interval).

FIG. 3E is a diagram 340 illustrating a digraph interval. In embodiments, the keystroke sequence includes the digraph interval. This is the duration 346, on a time axis 348, between pressing Key A 342 and releasing Key B 344.

FIG. 3F is a diagram 350 illustrating a trigraph interval. In embodiments, the keystroke sequence includes the trigraph interval. This is the duration 356, on a time axis 358, between pressing Key A 352, releasing Key A 352 and pressing Key B 354, and releasing Key B 354 and pressing Key C 359.

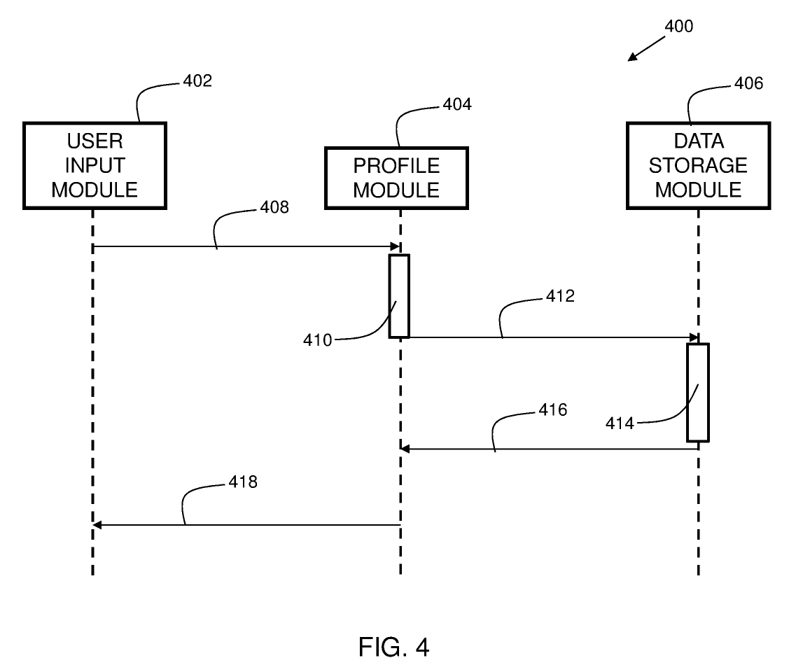

FIG. 4 is a sequence diagram 400 illustrating an initial training process in accordance with embodiments of the present invention. The training user input sequence is evaluated for a user after a user profile is created. This is the sample against which later inputs will be compared (i.e., the training data). The keystroke data is associated with user credentials data (such as user name and password). In the Figure, three modules are shown: user input module 402, profile module 404, and data storage module 406. The user input module 402 receives user input at 408 and sends it to profile module 404 at 408. The initial user input is evaluated by profile module 404 at 410. The initial user input is sent to data storage module 406 at 412. The initial user input is stored as the training user input sequence at 414 at the data storage module 406. A confirmation of the saving of the training user input sequence is sent at 416 to profile module 404. A confirmation of completion of the initial evaluation (i.e., training) session is sent at 418 to user input module 402.

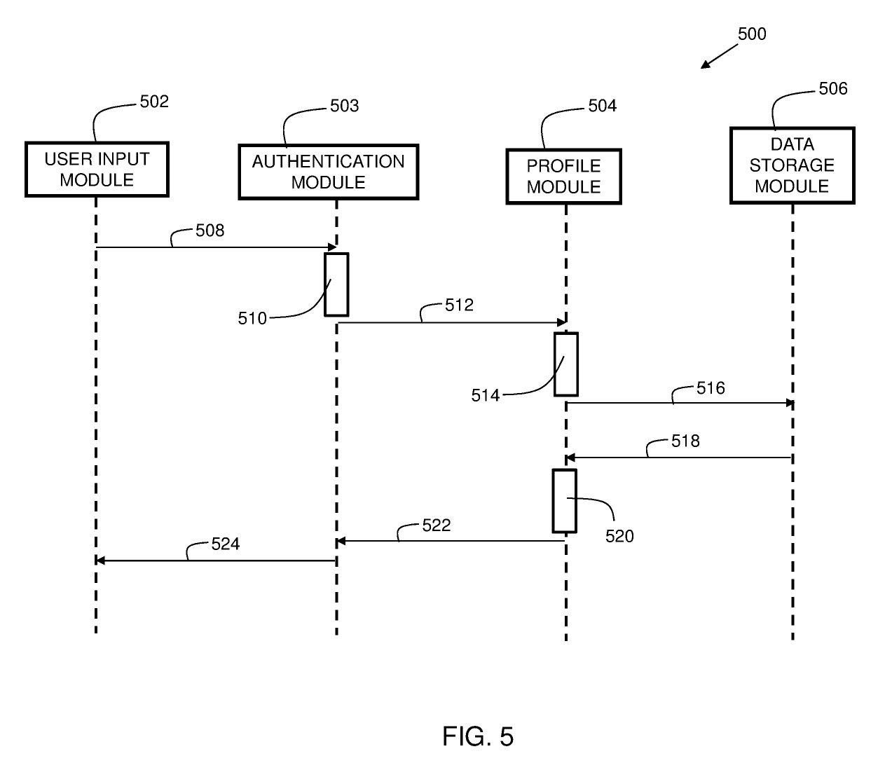

FIG. 5 is a sequence diagram 500 illustrating a login process in accordance with embodiments of the present invention. When a user logs in to a system, the training user input sequence previously recorded is retrieved and compared against the monitored user input sequence (measured user input data). Four modules are shown: user input module 502, authentication module 503, profile module 504, and data storage module 506. User input module 502 receives credentials (such as username and password) from the user for authentication. The user input module 502 sends the credentials to authentication module 503 at 508. At 510, the authentication module 503 checks the credentials against stored credentials to authenticate the user. At 512, the authentication module 503 sends a request for user profile information to profile module 504. At 516, the training user input sequence is evaluated. At 516, profile module 504 sends a request for the training user input sequence to the data storage module 506. Data storage module 506 returns the training user input sequence at 518 to profile module 503 at 520. Profile module 504 returns user profile information at 522 to authentication module 503. At 524, a confirmation of user access is then sent to user input module 502.

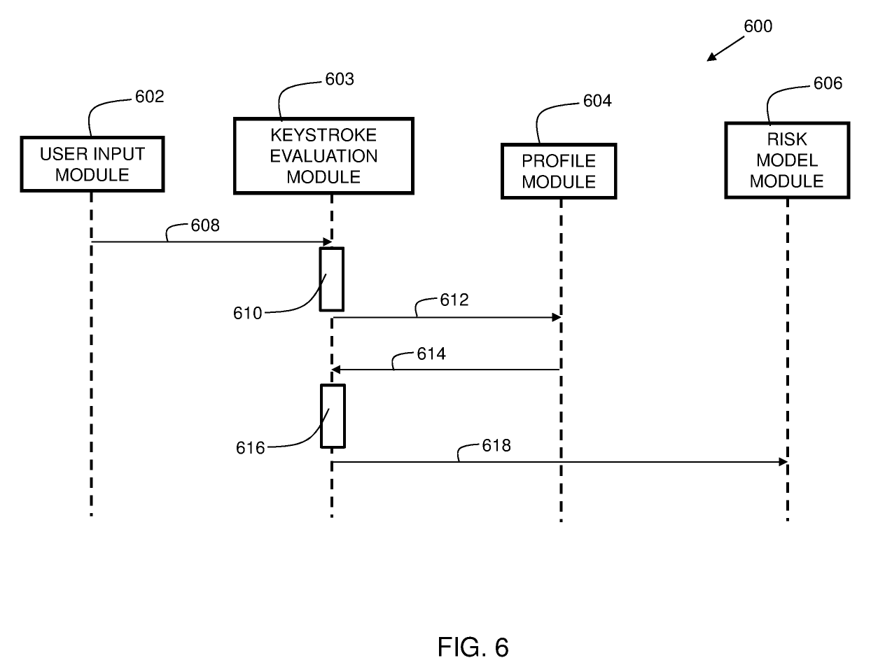

FIG. 6 is a sequence diagram 600 illustrating supply chain risk model adjustment based on keystroke evaluation in accordance with embodiments of the present invention. Measured data is compared against the training user input sequence, and risk is adjusted if needed. Four modules are shown: user input module 602, keystroke evaluation module 603, profile module 604, and risk model module 606. The user input module 602 receives user input and sends it to the keystroke evaluation module 603 at 608. Keystroke evaluation module 603 monitors the keystroke pattern of the user input and calculates keystroke dynamic metrics at 610. Keystroke evaluation module 603 sends a request for the training user input sequence to profile module 604 at 612. Profile module 604 returns the user keystroke dynamic metric to the keystroke evaluation module 603 at 614. Keystroke evaluation module 603 compares the monitored user input sequence from the user to the training user input sequence at 616. Keystroke evaluation module 603 provides the delta for adding a human risk factor, to risk model module 606 at 618.

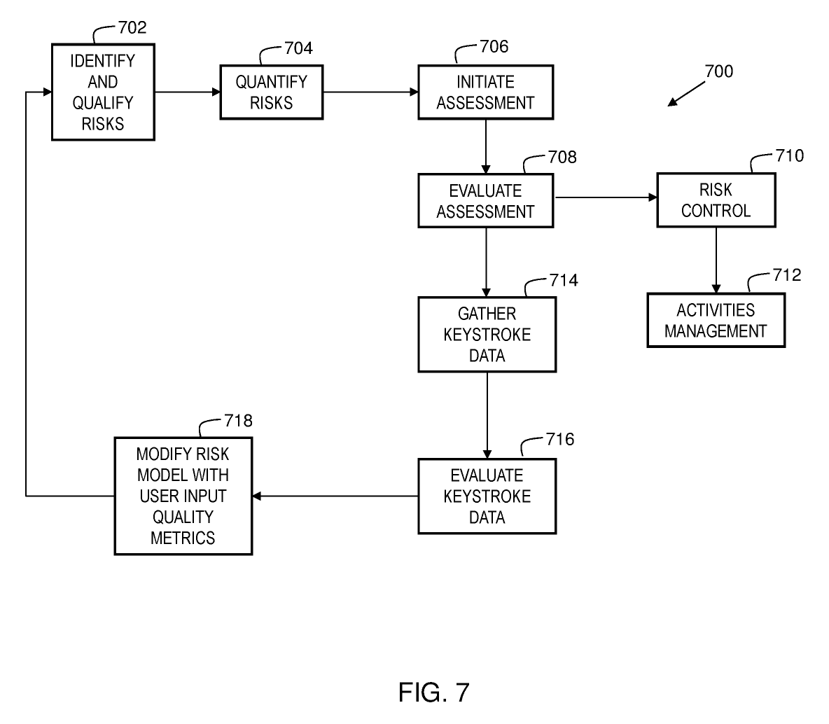

FIG. 7 is a flowchart 700 indicating process steps for embodiments of the present invention. At 702, risks are identified and qualified. This includes demand risks, supply risks, environmental risks, business risks, physical plant risks, and/or additional risks. At 704, risks are quantified. At 706, an assessment is initiated. At 708, the assessment is evaluated. At 710, risk is controlled. At 712, activities are managed. Elements 702 through 712 together represent standard risk management. Elements 714 through 718 enable the risk model to account for user input quality metrics in accordance with embodiments of the present invention. At 714, keystroke data is gathered. At 716, the gathered keystroke data is evaluated. At 718, the risk model is modified with user input quality metrics. In embodiments, obtaining a user input quality risk factor comprises determining a deviation between a training user input sequence and a monitored user input sequence. In embodiments, the user input quality U may be measured as follows:

U=ABS(Ti−Mi)

### Where:

Ti is the training input; and
Mi is measured input

The risk score S is the sum of the individual risk scores plus the user input quality

S=U+Σᵢ₌₁ⁿRiKi

Where:
U is user input quality
n is the number of risk factors under consideration
Ri are risk factors for a component (e.g., demand, supply, environmental . . . )
Ki are constants, which may be empirically tuned for achieving acceptable model performance.

In embodiments, the higher the score S, the greater the risk. In some embodiments, a threshold may be set. If the score is above the threshold, then it is deemed as a significant risk that needs to be brought to the attention of an administrator. If the score is below the threshold, then the risk is considered within acceptable limits.

It should be recognized that these formulas are examples, and any suitable computations may be included within the scope of the invention.

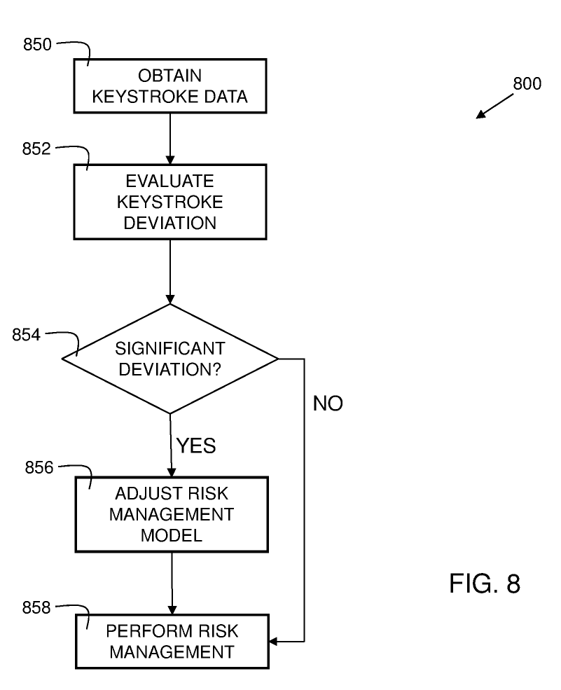

FIG. 8 is a flowchart 800 indicating process steps for additional embodiments of the present invention. At 850, keystroke data is obtained. At 852, keystroke deviation is evaluated. At 854, it is determined whether the deviation is significant. If not, risk management is performed at 858. If at 854, the deviation is significant, then the risk management model is adjusted at 856 based on user input quality, and then risk management is performed at 858.

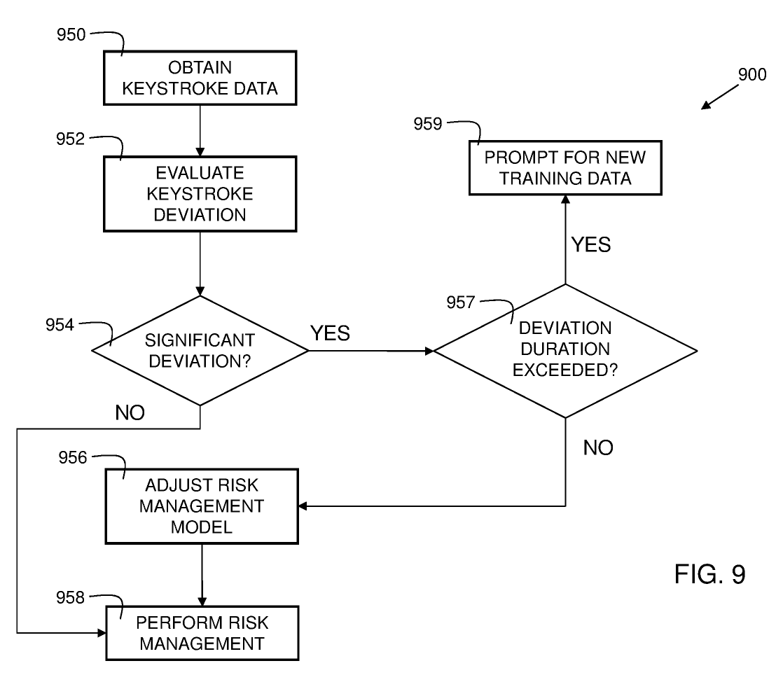

FIG. 9 is a flowchart 900 indicating process steps for additional embodiments of the present invention. Some embodiments will prompt to retrain if the deviation has been excessive for a long period (above a predetermined threshold). An example use case is when one first trains, s/he might not be totally proficient in a system. Over time though, s/he gets faster. A retraining will be needed so the current training user input sequence remains indicative of how s/he normally works. Accordingly, in some embodiments, at 950, keystroke data is obtained. At 952, keystroke deviation is evaluated. At 954, it is determined whether the deviation is significant. If not, then risk management is performed at 958. If the deviation is significant, then at 957, it is determined whether a deviation duration has been exceeded. The deviation duration threshold may be one week, three days, or another suitable time period. If the threshold has been exceeded, at 959, a prompt is issued for a new training user input sequence. If the threshold has not been exceeded, then at 956, the risk management model is adjusted to include user input quality, and then risk management is performed using the adjusted risk management model at 958.

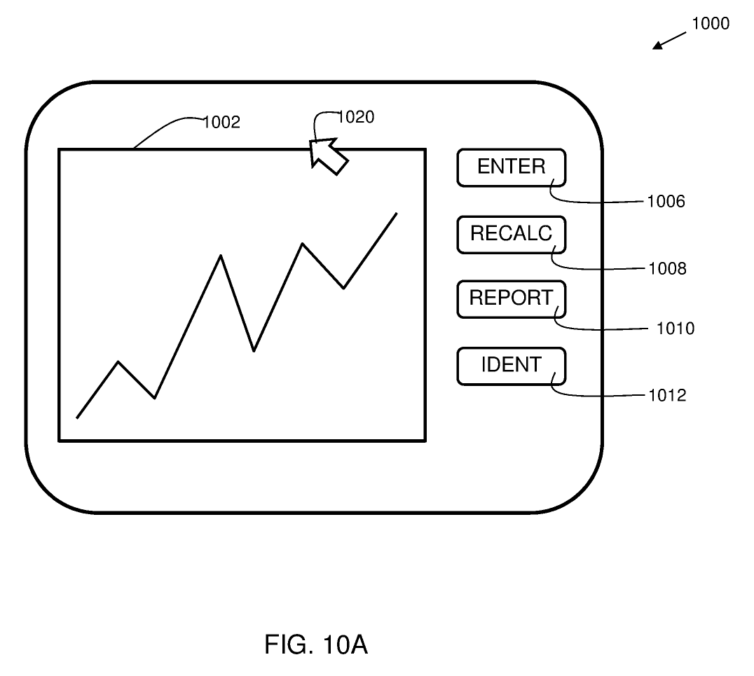

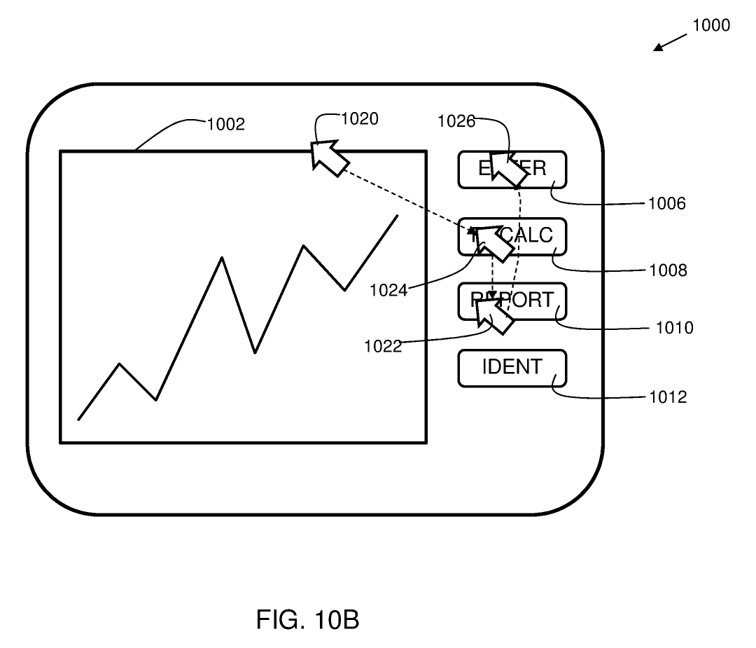

FIG. 10A and FIG. 10B show examples of performing a mouse usage analysis of a user. In some embodiments, rather than, or in addition to, analyzing type speed and patterns, a mouse usage analysis is performed. Accordingly, in embodiments, the monitored user input sequence comprises a mouse sequence. In some embodiments, the mouse sequence includes a cursor move event. In some embodiments, the mouse sequence includes a single-click event. In some embodiments, the mouse sequence includes a double-click event.

Referring to FIG. 10A, there is shown an example of a user interface 1000.

In the example, the user interface 1000 includes an image 1002, which is a graph. User interface 1000 further includes button 1006 for initiating an enter operation, button 1008 for initiating a recalculation operation, button 1010 for initiating a report generation operation, and button 1012 for initiating an identifying operation. The user interface 1000 is merely presented as an example to illustrate user interface navigation analysis. A cursor is also included at 1020. Cursor 1020 can be moved around the user interface by the user via a mouse, trackball, or other suitable cursor control device. FIG. 10B shows the user interface 1000 with a dashed line representing movement of the cursor 1020 by the user. As shown, the cursor starts at the location indicated by 1020. It is then moved by the user to position 1024 where the user clicks the recalculation button 1008. The cursor is then moved by the user to position 1022 where the user clicks on the report button 1010. The cursor is then moved by the user to position 1026 where the user double clicks on the enter button 1006.

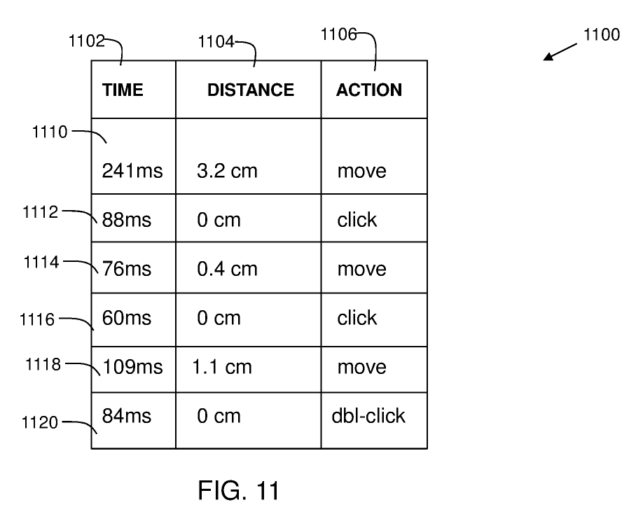

FIG. 11 shows a timing table 1100 for a mouse usage analysis. In embodiments, the analysis may take into account the cursor path, click speed, type speed, etc. In the example table 1100, three columns are shown. The columns are titled “time” 1102, “distance” 1104, and “action” 1106. Action column 1106 shows the nature of user actions, such as move, click, or double-click. The time column 1102 indicates the timing between actions, and the distance column 1104 shows the distance traveled by the cursor between actions. These times may be established as part of an initial training user input sequence. Then, at a future time, when the user is performing similar cursor actions, the timing of those actions (monitored user input sequence) is compared with the actions of the initial training user input sequence, and a deviation is computed, based on the difference in timing for various events such as movement, clicks, and/or double-clicks.

As shown in FIG. 11, the attributes from the example of FIG. 10B are detected and recorded as follows. Row 1110 represents the cursor's move from position indicated at 1020 a distance of 3.2 centimeters to the position indicated at 1024. Row 1112 represents the click at position 1024 of recalculation button 1008. Row 1114 represents the cursor's move from position 1024 a distance of 0.4 centimeters to position 1022. Row 1116 represents the click at position 1022 of report button 1010. Row 1118 represents the cursor's move from position 1022 a distance of 1.1 centimeters to position 1026. Row 1120 represents the double-click at position 1026 of enter button 1006.

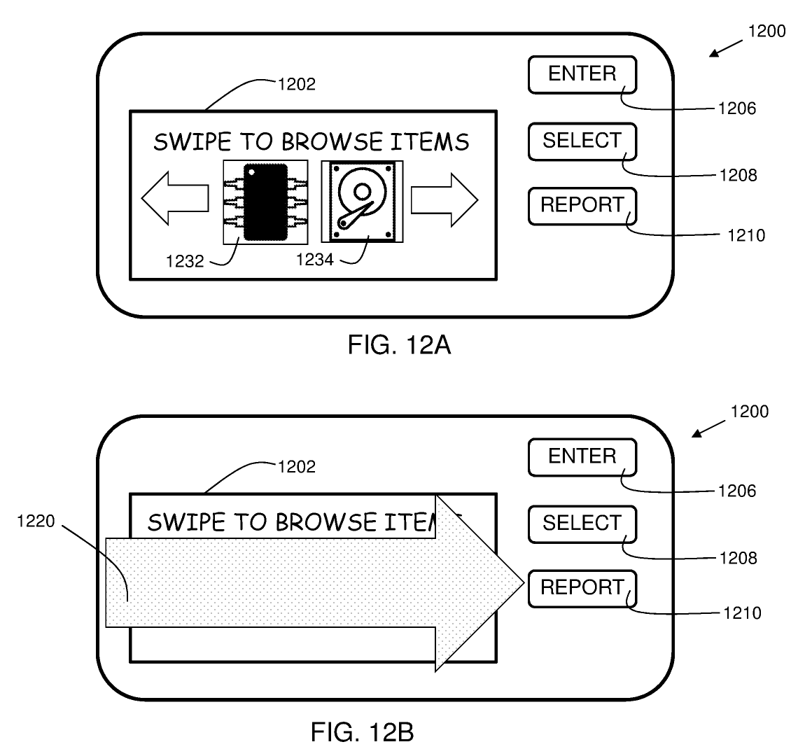

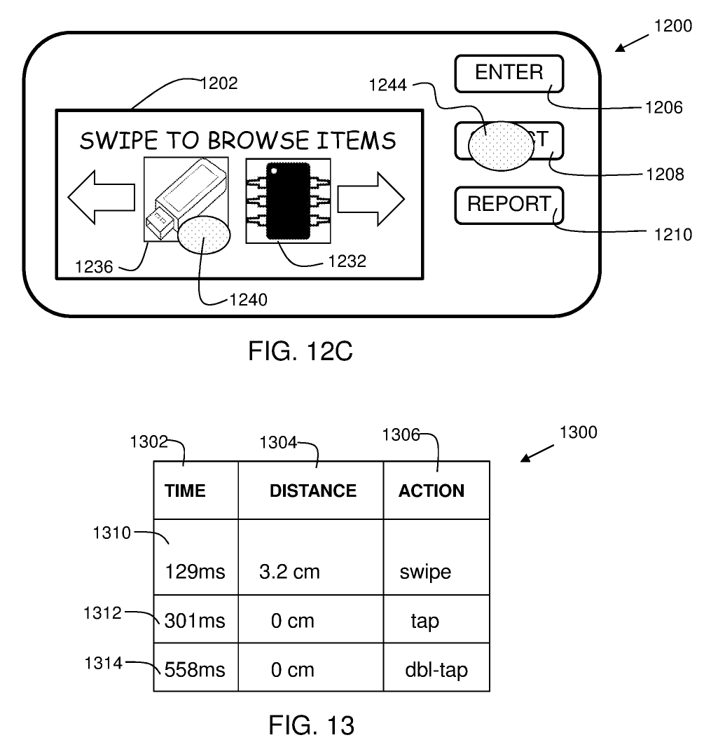

FIGS. 12A-12C show examples of performing a touchscreen usage analysis of a user. In some embodiments, rather than, or in addition to, analyzing type speed and patterns, a touchscreen usage analysis is performed. Accordingly, in embodiments, the monitored user input sequence comprises a touchscreen sequence. In some embodiments, the touchscreen sequence includes a swipe event. In some embodiments, the touchscreen sequence includes a tap event. In some embodiments, the touchscreen sequence includes a double-tap event.

FIG. 12A shows an example user interface screen 1200. Screen 1200 allows a user to swipe the screen to browse items at 1202. An icon of an integrated circuit is displayed at 1232 and an icon of a hard disk is displayed at 1234 in the queue of products. The user interface screen 1200 includes buttons 1206, 1208, and 1210. Button 1206 is for an “enter” function. Button 1208 is for a “select” function. Button 1210 is for a “report” function. FIG. 12B shows user interface screen 1200 with a representation of a user swiping across the screen at arrow 1220. FIG. 12C shows user interface screen 1200 after (in response to) the swipe event. Icon 1232 is shown to the right of the position it was in in FIG. 12A. Icon of a USB drive 1236 is shown to the left of icon 1232. A user taps a finger on icon 1236 at 1240, and then double-taps a finger on button 1208 at 1244.

FIG. 13 shows a timing table 1300 for a touchscreen usage analysis. The table shows the timing, distance, and actions recorded in the sequence of FIGS. 12A-12C. In the example, columns are shown with example data. Column 1302 records timing. Column 1304 records distance. Column 1306 records actions. In row 1310, at a time of 129 milliseconds (ms), a swipe of 3.2 cm across the screen is detected. The swipe may be of the user's finger or a stylus on a touch screen. In row 1312, at a time of 301 ms, a tap of the screen is detected. In row 1314, at a time of 558 ms, a double-tap of the screen is detected.

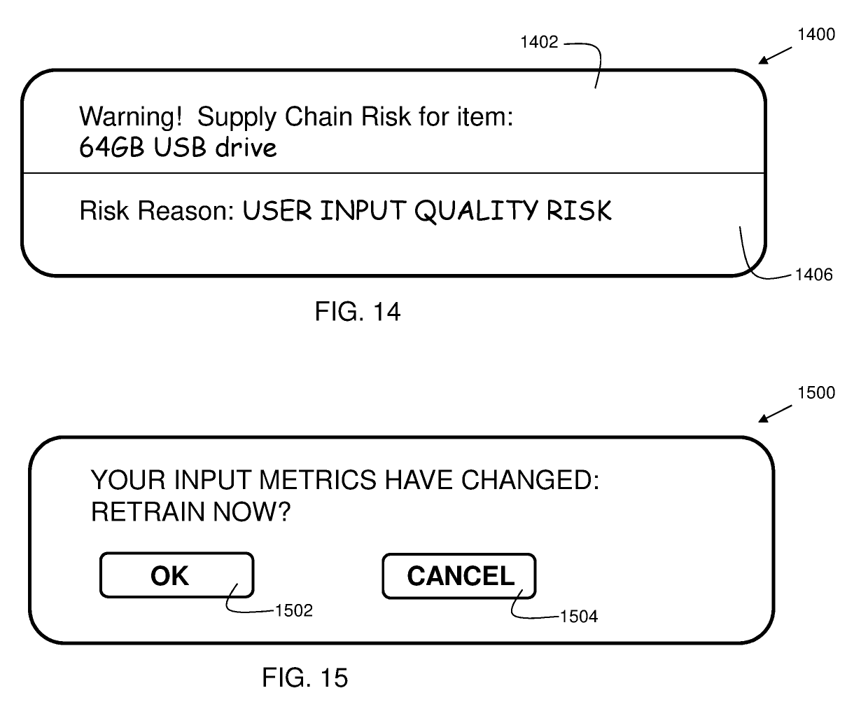

FIG. 14 shows an exemplary risk warning 1400 in accordance with embodiments of the present invention. In some embodiments, a warning may be issued when a risk for an item is detected based on user input quality. In the example, the user interface 1400 shows warning 1402 reciting, “Warning! Supply Chain Risk for item: 64 GB USB drive.” User interface 1400 also shows the risk reason at 1406, reciting, “USER INPUT QUALITY RISK.” The warning/reason here are examples, and any suitable setup is included within the scope of the invention.

FIG. 15 shows an exemplary retraining prompt user interface 1500 in accordance with embodiments of the present invention. In some embodiments, a number of user input deviations may be recorded within a predetermined time interval. In response to the number of user input deviations exceeding a predetermined threshold, a prompt may be presented, on an electronic display, for entry of a new training user input sequence. The prompt may indicate to the user that input metrics have changed, and ask whether the user wishes to retrain. The user interface may include options for the user. If the user wishes to retrain now, the user may select the “OK” button. If the user wishes not to retrain, s/he may select the “CANCEL” button. These options are examples, and any suitable options achieving the same goals may be presented. For example, in some embodiments, the user may choose to retrain at a later time and may be able to select the time.

As can now be appreciated, disclosed embodiments provide improvements to the technical field of supply chain risk management. Disclosed embodiments include user input quality in supply chain risk modeling. This accounts for potential data entry errors that can skew the supply chain picture. Supply chain disruptions can be catastrophic for a business, so any refinement that better assesses the risk can be a significant advantage. Embodiments include providing notifications of excessive risk for an item, and may further include a notification that the item is associated with user input data of above average risk. This gives an opportunity for stakeholders to review associated user input data with extra scrutiny, enabling the early detection of supply chain information errors. This can give an important advantage to a business by giving it extra time to apply mitigation strategies as needed to maintain a consistent supply chain.

Some of the functional components described in this specification have been labeled as systems or units in order to more particularly emphasize their implementation independence. For example, a system or unit may be implemented as a hardware circuit comprising custom VLSI circuits or gate arrays, off-the-shelf semiconductors such as logic chips, transistors, or other discrete components. A system or unit may also be implemented in programmable hardware devices such as field programmable gate arrays, programmable array logic, programmable logic devices, or the like. A system or unit may also be implemented in software for execution by various types of processors. A system or unit or component of executable code may, for instance, comprise one or more physical or logical blocks of computer instructions, which may, for instance, be organized as an object, procedure, or function. Nevertheless, the executables of an identified system or unit need not be physically located together, but may comprise disparate instructions stored in different locations which, when joined logically together, comprise the system or unit and achieve the stated purpose for the system or unit.

Further, a system or unit of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices and disparate memory devices.

Furthermore, systems/units may also be implemented as a combination of software and one or more hardware devices. For instance, location determination and alert message and/or coupon rendering may be embodied in the combination of a software executable code stored on a memory medium (e.g., memory storage device). In a further example, a system or unit may be the combination of a processor that operates on a set of operational data.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor devices, chips, microchips, chip sets, and so forth. However, the embodiments are not limited in this context.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values, or symbols arranged in a predetermined syntax that, when executed, may cause a processor to perform a corresponding set of operations.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, may be non-transitory, and thus is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Program data may also be received via the network adapter or network interface.

Computer readable program instructions for carrying out operations of embodiments of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of embodiments of the present invention.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

While the disclosure outlines exemplary embodiments, it will be appreciated that variations and modifications will occur to those skilled in the art. For example, although the illustrative embodiments are described herein as a series of acts or events, it will be appreciated that the present invention is not limited by the illustrated ordering of such acts or events unless specifically stated. Some acts may occur in different orders and/or concurrently with other acts or events apart from those illustrated and/or described herein, in accordance with the invention. In addition, not all illustrated steps may be required to implement a methodology in accordance with embodiments of the present invention. Furthermore, the methods according to embodiments of the present invention may be implemented in association with the formation and/or processing of structures illustrated and described herein as well as in association with other structures not illustrated. Moreover, in particular regard to the various functions performed by the above described components (assemblies, devices, circuits, etc.), the terms used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of embodiments of the invention may have been disclosed with respect to only one of several embodiments, such feature may be combined with one or more features of the other embodiments as may be desired and advantageous for any given or particular application. Therefore, it is to be understood that the appended claims are intended to cover all such modifications and changes that fall within the true spirit of embodiments of the invention.

What is claimed is:

1. A computer-implemented method for assessing supply chain risk, comprising:
obtaining a plurality of supply chain risk factors for a supply chain;
obtaining a user input quality risk factor;
computing a risk score for a supply chain based on the obtained supply chain risk factors and the user input quality risk factor; and
presenting a risk warning on an electronic display, wherein the risk warning is based on the risk score.

2. The method of claim 1, wherein obtaining a user input quality risk factor comprises determining a deviation between a training user input sequence and a monitored user input sequence.

3. The method of claim 2, wherein the monitored user input sequence comprises a keystroke sequence.

4. The method of claim 2, wherein the monitored user input sequence comprises a mouse sequence.

5. The method of claim 2, wherein the monitored user input sequence comprises a touchscreen sequence.

6. The method of claim 3, wherein the keystroke sequence includes a release-press interval.

7. The method of claim 3, wherein the keystroke sequence includes a release-release interval.

8. The method of claim 3, wherein the keystroke sequence includes a dwell interval.

9. The method of claim 3, wherein the keystroke sequence includes a flight time interval.

10. The method of claim 3, wherein the keystroke sequence includes a digraph interval.

11. The method of claim 3, wherein the keystroke sequence includes a trigraph interval.

12. The method of claim 4, wherein the mouse sequence includes a cursor move event.

13. The method of claim 4, wherein the mouse sequence includes a single-click event.

14. The method of claim 4, wherein the mouse sequence includes a double-click event.

15. The method of claim 5, wherein the touchscreen sequence includes a swipe event.

16. The method of claim 5, wherein the touchscreen sequence includes a tap event.

17. The method of claim 5, wherein the touchscreen sequence includes a double-tap event.

18. The method of claim 1, further comprising the steps of:
recording a number of user input deviations within a predetermined time interval; and
in response to the number of user input deviations exceeding a predetermined threshold, presenting a prompt, on an electronic display, for entry of a new training sequence.

19. An electronic computation device comprising:
a processor;
a memory coupled to the processor, the memory containing instructions, that when executed by the processor, perform the steps of:
obtaining a plurality of supply chain risk factors for a supply chain;
obtaining a user input quality risk factor;
computing a risk score for a supply chain based on the obtained supply chain risk factors and the user input quality risk factor; and
presenting a risk warning on an electronic display, wherein the risk warning is based on the risk score.

20. A computer program product for an electronic computation device comprising a computer readable storage medium having program instructions embodied therewith, the program instructions executable by a processor to cause the electronic computation device to:
obtain a plurality of supply chain risk factors for a supply chain;
obtain a user input quality risk factor;
compute a risk score for a supply chain based on the obtained supply chain risk factors and the user input quality risk factor; and
present a risk warning on an electronic display, wherein the risk warning is based on the risk score.
